(19) United States
(12) Patent Application Publication
(10) Pub. No.: US 2018/0304277 A1
(43) Pub. Date: Oct. 25, 2018

(54) METHODS AND APPARATUS FOR THE CONTINUOUS MONITORING OF WEAR AND PRESSURE IN CENTRIFUGAL CONCENTRATORS

(71) Applicant: FLSMIDTH A/S, Valby (DK)

(72) Inventors: Robert Heinrichs, Abbotsford (CA); Mike MCLEAVY, Surrey (CA)

(21) Appl. No.: 15/522,433

(22) PCT Filed: Nov. 25, 2015
(86) PCT No.: PCT/IB2015/059132

§ 371 Date: Apr. 27, 2017

(51) Int. Cl. B04B 1/08; B04B 15/12; B04B 7/06; B04B 7/14; G01N 3/56

(52) U.S. Cl. CPC B04B 1/08; B04B 15/12; B04B 2013/006; B04B 7/14; G01N 3/56; B04B 7/06

(57) ABSTRACT

A system for the continuous monitoring of wear and/or pressure within a gravity concentrator/centrifugal separator [10] is disclosed. The system may comprise a gravity concentrator/centrifugal separator [10] having a cone [30], rotor housing shell [20], and water jacket [40]. At least one detector [34] may be provided to at least one of the cone [30], rotor housing shell [20], and water jacket [40]. At least one integrated or handheld sensor [60] may be provided adjacent to portions of the gravity concentrator/centrifugal separator [10], the sensor [60] being configured to communicate (e.g., wirelessly) with the at least one detector [34] during operation of the gravity concentrator/centrifugal separator [10]. In use, the cone [30] may wear away and ultimately affect a function of the least one detector [34]. In use, pressure changes within the water jacket [40] may change and ultimately affect a function (e.g., an output signal) of the least one detector [34]. The at least one sensor [60] may be configured to monitor said function(s) of the least one detector [34]. When the at least one sensor [60] detects a change in the signal of the at least one detector [34], an operator or control system may be notified that maintenance or cone [30] replacement may be necessary; and/or an operator or control system may be notified that one or more operational inputs may need to be adjusted to obtain peak performance of the gravity concentrator/centrifugal separator [10].

### CROSS-REFERENCE TO RELATED APPLICATIONS

This application claims the benefit of United States Provisional Patent Application No. 61/980,481 titled “Methods and Apparatus for the Continuous Monitoring of Wear and Pressure in Centrifugal Concentrators” and filed on 26 Nov. 2014. This application also relates to U.S. Provisional Patent Application No. 61/980,481 titled “Methods and Apparatus for the Continuous Monitoring of Wear in Flotation Circuits” and filed on 16 Apr. 2014 and further relates to International Patent Application No. PCT/EP2014/060342 titled “Methods and Apparatus for the Continuous Monitoring of Wear in Grinding Circuits” and filed on 20 May 2014. All of the aforementioned applications are hereby incorporated by reference in their entirety, for any and all purposes, as if fully set forth herein.

### FIELD OF THE INVENTION

This invention relates to equipment and processes for improving the productivity, the usable life, and/or the efficiency of centrifugal (i.e., “gravity”) concentrator/separator apparatus and components thereof. More particularly, this invention relates to methods of monitoring the wear of cones, cone assemblies, and cone components within gravity concentrators, as well as systems and apparatus for accomplishing the same. Additionally, this invention relates to methods of monitoring water jacket pressures and/or pressure profiles within a gravity concentrator, and systems and apparatus for accomplishing the same.

### BACKGROUND OF THE INVENTION

Centrifuges, in particular, gravity concentrators predominantly utilized in the gold mining industry (e.g., those manufactured by FLSmidth—Knelson, Falcon, or iCON), may use polyurethane-cast or polyurethane-coated cones. The cones may be assembled within a rotating rotor housing shell. Examples of such centrifugal separator devices may be seen in U.S. Pat. No. 8,808,155; U.S. Pat. No. 7,500,943; U.S. Pat. No. 7,503,888; U.S. Pat. No. 7,144,360; U.S. Pat. No. 6,997,859; U.S. Pat. No. 6,149,572; U.S. Pat. No. 6,986,732; U.S. Pat. No. 6,962,560; U.S. Pat. No. 5,601,523; U.S. Pat. No. 5,601,524; U.S. Pat. No. 5,586,965; U.S. Pat. No. 5,338,284; U.S. Pat. No. 5,368,541; U.S. Pat. No. 5,728,039; U.S. Pat. No. 5,222,933; U.S. Pat. No. 5,372,571; U.S. Pat. No. 5,230,797; U.S. Pat. No. 5,372,571; U.S. Pat. No. 5,354,256; U.S. Pat. No. 5,087,127; U.S. Pat. No. 4,983,156; U.S. Pat. No. 4,846,781; U.S. Pat. No. 4,776,833; U.S. Pat. No. 4,608,040; Canadian Patent No. 2,625,841; Canadian Patent No. 2,625,843; Canadian Patent No. 1,301,725; Canadian Patent No. 1,111,809; Canadian Patent No. 1,279,623; Canadian Patent No. 1,240,653; British Patent No. 8505178; British Patent No. 8828539; WIPO Publication No. WO07143817; WIPO Publication No. WO05011872; WIPO Publication No. WO97000728; and Australian Patent No. AU198280202, without limitation.

The cone, and rotor housing shell, may collectively form an assembly that moves in concert, rotationally, about a vertically-extending axis. The assembly may spin at high RPM, to create high gravitational force environments to force separations of heavy target metals (e.g., gold) from gangue or less important mineral compositions. While spinning, slurry may be pumped into the concentrator, forced downwards, and centrally disposed into the cone base. This entering slurry may be subsequently flung radially outwardly and move upwardly and radially outwardly so as to cascade over a series of troughs and peaks which are formed in radially inwardly facing surfaces of the cone. Heavier target metals (e.g., gold) may settle in the valleys in the cone and therefore, may be captured, wherein lighter gangue particles may float over the troughs and peaks and may eventually be flung radially-outwardly and upwardly over a launder within the gravity concentrator. In order to keep the process going, the bottoms of said troughs/valleys may be fluidized to ensure that no gangue (or a minimal amount of gangue) settles within the troughs/valleys of the cone. Fluidization may also help ensure that gangue passes up and over the launder and that substantially only heavier target metals (e.g., gold) remain trapped within the cone. This may be accomplished by pressurizing a water jacket formed between the cone and rotor housing shell, and placing a plurality of radially-extending fluidization holes through the troughs/valleys of the cone. The fluidization holes may be disposed at an angle, the angle having a radially-extending component and an optional tangential component to it. In other words, the fluidization holes may not be perfectly radially-aligned to the axis of rotation of the assembly.

Cones of gravity concentrators are often replaced due to wear. However, gold processing operations generally cannot afford excessive downtime to continually shut down and inspect cone surface conditions too often. Gold processing operations also generally cannot afford to wait too long to replace worn down cones, as this could affect function, operation, and therefore negatively-impact gold recovery. For instance, target metals (e.g., gold) may be lost if the radially-inwardly extending peaks of the cone wear away and do not function as intended. Accordingly, there has been a long-felt need in the art, for operators to be able to readily identify a physical condition of a gravity concentrator cone, during operation or in-situ, so as to more easily determine its effective useful remaining life and/or more efficiently schedule machine downtimes.

Time-consuming repair processes, if performed too often, may result in losses such as premature cone replacement (i.e., increased operational expenditures/CAPEX), superfluous operational downtime, increased labor costs, and reduced throughput. Conversely, if the repair process is performed too infrequently, other expensive losses such as mechanical failure, loss of valuable precious metals, inefficient concentration/separation performance, and/or poor material separations may occur.

Since cone surface wear is not visually typically observable in operation of a gravity concentrator (due to a layer of slurry running over-top of its inner surfaces), a plant operator may need to stop the gravity concentrator, discharge remaining slurry from the concentrator, wipe the cone, and then gain physical internal access to the concentrator to have a closer look and visual inspection. This takes a significant amount of time and may further reduce plant throughput. Certain embodiments of the systems and methods disclosed herein may provide continuous in-situ monitoring of the state of wear of the gravity concentrator cones during operation, so that the current state of wear can be known without necessarily halting the operation of the gravity concentrator to accommodate a manual visual inspection. Moreover, according to certain embodiments of the systems and methods disclosed herein, water jacket pressure profiling can be performed to optimize operating parameters of a concentrator. Operating parameters may include, without limitation, RPM, cycle time (e.g., for batch or intermittent continuous cycles), residence time, power/energy inputs, fluidization hole pressures, water jacket pressures, slurry feed rates, and the like.

Many variations of wear management systems have been attempted in the minerals processing arts. One example of a conventional wear management system is the Krebs SmartCyclone™ system provided by FLSmidth. Another example of a wear management system may be found in co-pending U.S. Provisional Patent Application No. 61/980,481 titled: “Methods and Apparatus for the Continuous Monitoring of Wear in Flotation Circuits”. Yet another example of a wear management system in the minerals processing arts may be found in co-pending International PCT Application No. PCT/EP2014/060342 titled: “Methods and Apparatus for the Continuous Monitoring of Wear in Grinding Circuits”. Other examples of conventional wear-management systems may be found in the following patents and patent application publications, without limitation: U.S. Pat. No. 4,646,001; U.S. Pat. No. 4,655,077; U.S. Pat. No. 5,266,198; U.S. Pat. No. 6,080,982; U.S. Pat. No. 6,686,752; U.S. Pat. No. 6,945,098; and US Patent Application Publication No. 2003/0209052.

### OBJECTS OF THE INVENTION

It is, therefore, an object of some embodiments of the present invention, to provide a method of notifying an operator when a liner of a gravity concentrator has reduced in diameter by a preset amount, for example, to indicate one or more wear thresholds.

It is also an object of some embodiments of the present invention, to provide a method of notifying an operator of pressure profile information pertaining to a water jacket operatively engaging a cone of a gravity concentrator, for example, to improve concentrator efficiency.

It is also an object of some embodiments of the present invention, to enable the practice of efficient proactive scheduling of maintenance, based on quantitative data obtained while a gravity concentrator, centrifugal separator, or metal value concentration circuit remains in service.

A further object of some embodiments of the present invention might include providing an operator with the ability to schedule gravity concentrator maintenance based on actual measured wear data, thereby optimizing concentrator capacity, throughput, RPM, energy consumption, cone life, and/or manpower.

It is also an object of some embodiments of the present invention, to improve the efficiency of existing concentrator circuits currently in operation, by extending or maximizing the usable life of gravity concentrator cone apparatus and components thereof, for example, without incurring detrimental metal value losses associated with excessive wear.

It is a further object of some embodiments of the present invention, to provide a system and apparatus which is configured to indicate, in real-time, whether or not a cone needs to be replaced, without the need for intermittent or reoccurring temporary decommissioning, cleaning, and/or manual visual inspection.

Moreover, an object according to some embodiments of the present invention may include providing a cost-friendly, economical way for plant owners to subsidize plant operations, offset maintenance costs, justify large start-up capital expenditures, and/or lower overhead costs.

It is a further object of some embodiments of the present invention, to provide an operator of a gravity concentrator, with real-time water jacket pressure profile information which is associated with a cone of the gravity concentrator, and in some instances, even while the water jacket pressure profile is in use.

It is yet a further object of some embodiments of the present invention, to provide a system and apparatus which provides the ability for an operator to learn if fluidization holes in a concentrator cone have been fully or partially occluded, in real-time, during operation.

It is yet a further object of some embodiments of the present invention, to provide a system and apparatus which provides the ability for an operator to make various small adjustments and compensations, for example, to make small adjustments to water flow to a cone, in order to optimize the ‘fill’ of the water jacket of a gravity concentrator, in real-time.

Another object according to some embodiments of the present invention, may include providing a system and apparatus which might allow an operator to correlate a required pressure gradient to a grade or type of recovered metal or laundered gangue (due to gradual fill/packing of concentrator rings with heavy target materials and/or gangue).

Yet another object according to some embodiments of the present invention, may be to provide a system and apparatus for optimizing performance via a pressure profile-driven batch cycle or via a pressure profile-driven continuous run cycle, rather than via a purely time-based run cycle—which has been conventionally used to date.

Yet even another object according to some embodiments of the present invention, may be to allow an operator to monitor an amount of wearing of individual or specific urethane rings (i.e., troughs and/or peaks) of a gravity concentrator cone.

Another object according to some embodiments of the present invention, may be to allow monitoring of the pressure profiling of a spinning water jacket, the spinning water jacket being disposed outside of a gravity concentrator cone and within a rotor housing shell, wherein the various apparatus, systems, and methods disclosed herein may more specifically allow pressures at the back of the urethane concentrator rings to be monitored. In this regard, RPM, power, or fluid pressure variables may be adjusted by an operator or control system to optimize fluidization and/or avoid or mitigate the occlusion of fluidization holes.

These and other objects of the present invention will be apparent from the drawings and description herein. Although every object of the invention is believed to be attained by at least one embodiment of the invention, there is not necessarily any one embodiment of the invention that achieves all of the objects of the invention.

### SUMMARY OF THE INVENTION

Proposed, are various systems and methods for detecting amounts of cone wear within a gravity concentrator during its operation, particularly for detecting reaching an unacceptable threshold of wear in soft lining material of a cone, the soft lining material forming a plurality of ridges and troughs (i.e., “concentrator rings”). Also proposed, are methods for indicating a remaining life of said cone to an operator or control system in order to adjust, optimize, or prioritize gravity concentrator maintenance schedules and/or reduce machine downtime. Further proposed, are methods for monitoring, measuring, indicating, and using information pertaining to a pressure profile of a water jacket associated with said cone. In this regard, run cycles and/or slurry residence time(s) may be adjusted and/or optimized both statically, and/or dynamically, based on pressure profile, rather than set by a predetermined “run time” as conventionally done to date.

A system for the continuous monitoring of wear and/or pressure within a gravity concentrator is disclosed. The system comprises a gravity concentrator having a cone assembly comprised of a cone, a rotor housing shell, and a water jacket between the cone and rotor housing shell. At least one detector may be provided to at least one of the cone and rotor housing shell. At least one sensor may be provided to the gravity concentrator, which is configured to communicate with the at least one detector during operation of the gravity concentrator. The at least one detector may be an RFID tag, a wireless pressure transducer which may work on a similar or different frequency as the RFID tag, if present, or a combination thereof. In use, soft material portions of the cone (including concentrator rings) may wear away, thus, subsequently exposing the at least one detector to slurry. Accordingly, a function of the least one detector may be affected. The at least one detector may stop working (e.g., fail to deliver a signal or voltage when exposed to abrasive liquid in the slurry when used sacrificially), or it may experience a change in voltage (e.g., when portions of the at least one detector are exposed to abrasive liquid in the slurry), of which a sensor may detect.

Moreover, pressure within the water jacket may change over time, and ultimately affect a function of the least one detector. For example, a change or changes in the strength of signal or a change or changes in a signal emitted from the at least one detector may be experienced by a sensor when a localized pressure within the water jacket changes. By virtue of communication with the at least one detector, the at least one sensor may be configured to monitor a function or status of the least one detector and may further determine whether the operational status of the cone is within an acceptable range, above a predetermined (e.g., “minimum”) threshold, and/or below a predetermined (e.g., “maximum”) threshold. Alternatively, or in addition to determining the operational status of the cone, by virtue of monitoring the function or status of the at least one detector, a real-time pressure profile at one or more regions of the water jacket may be determined. This may be accomplished through the use of multiple detectors strategically positioned within certain localized areas of the water jacket as shown in FIGS. 8 and 9. In some embodiments, the at least one detector may comprise an RFID tag, wireless pressure transducer, or combination thereof. In some embodiments, the at least one sensor may comprise a reader/interrogator. In some embodiments, each detector may have its own unique identifier, such as its own unique frequency, signal, or voltage.

In some embodiments, the RFID tag may comprise a low-frequency RFID tag and the at least one sensor may comprise a low-frequency detector/identifier in the kHz range of frequencies. In some embodiments, the at least one detector may comprise an ultra-high frequency RFID tag, and the at least one sensor may comprise an ultra-high frequency detector/identifier in the MHz range of frequencies. In some embodiments, the RFID tag may comprise a microwave RFID tag, and the at least one sensor may comprise a microwave detector/identifier which operates in the GHz range of frequencies. In other embodiments, the at least one detector may comprise a magnet and the at least one sensor may comprise a Hall Effect sensor. In yet further embodiments, the at least one detector may comprise a wafer-style probe comprising a printed circuit board (PCB). In some instances, the at least one detector may comprise a radioisotope capable of emitting alpha particles and/or low energy gamma rays, and the at least one sensor may comprise a radioisotope detector/identifier, wherein the at least one sensor may be configured to detect the radioisotope when the at least one detector becomes fully or partially exposed after a predetermined amount of cone wear (e.g., degradation of polyurethane encasing the at least one detector). According to some embodiments, the at least one detector may comprise a self-powered RF-emitting wireless micro-transmitter, and the at least one sensor may comprise a receiver tuned to the same frequency as said RF-emitting wireless micro-transmitter.

In some embodiments, a low voltage closed circuit may be used to determine wear of a concentrator cone. In this regard, a loop of wire connected to a detector having an onboard circuit and power supply may be positioned on a skeletal frame of a cone, prior to molding, in a circumferential loop. For example, the loop of wire may be positioned along a rib of the frame. The loop of wire (and optionally the wireless detector) may be embedded into the cone via the same over-molding techniques which are used to form the completed cone. The loop of wire may be strategically positioned at a constant radial distance from inner surfaces of the cone, or in a small loop at one or more radial cone locations. In use/operation, if cone wear (from abrasive slurry) progresses past a predetermined point, the loop of wire may be exposed to the abrasive slurry and erode to the point of breakage, destroying the closed circuit and consequently notifying an operator or control system that the cone needs replacing, servicing, or refurbishment, due to excessive wear. In some preferred embodiments, the loop of wire may be thin or of a very fine gauge to facilitate breakage when exposed to abrasive slurry. In some preferred embodiments, multiple loops of embedded wire may extend circumferentially around various portions of a cone to detect wear along various vertical locations along an axis of rotation of the cone. In some preferred embodiments, multiple loops of wire may share a single detector and be connected in parallel. In some preferred embodiments, multiple loops of wire may share a single detector and be connected in series (e.g., the multiple loops of wire may comprise a single helical coil of wire which covers a majority of the surface area of a cone). In some preferred embodiments, the circuit may be activated intermittently, at predetermined intervals, rather than operate continuously, in order reduce drainages—particularly for embodiments employing an onboard battery for the detector(s). For example, one or more detectors may be configured with a “heartbeat” setting which may enable reads for up to between approximately 1-2 years and beyond, without limitation.

In some embodiments, the detector may be a wireless water sensor or probe which is configured to detect the presence of water between two leads. In such embodiments, the leads may be connected to form the loop of wire. When the loop breaks due to erosive wear of cone polymer (e.g., polyurethane), water may be detected between the two leads, and the wireless water sensor or probe may subsequently signal an operator of the gravity concentrator/centrifugal separator, and/or signal the machine's control system, and indicate that there may be excessive cone wear which may negatively impact machine efficiency and/or gold recovery.

In some embodiments, leads extending from a wireless water sensor or probe may be mounted to a cone skeletal frame, and then subsequently embedded within cone polymer (e.g., polyurethane), such that there is a small spacing between the leads. In this regard, in the event substantial polyurethane wear occurs adjacent the tips of the leads, and water from slurry subsequently collects between the tips of the lead tips, water may be detected between the two leads. When water is detected between the two leads, the wireless water sensor or probe may subsequently signal an operator of the gravity concentrator/centrifugal separator, and/or signal the machine's control system, and indicate that there may be excessive cone wear which may negatively impact machine efficiency and/or gold recovery. One non-limiting example of such a wireless water sensor or probe is a Monnit™ 900 MHz Commercial (3.0V Coin Cell Battery) Wireless Water Sensor (PN: MNS-9-WS-W1-LD) manufactured by Monnit Corp.

In some embodiments, the at least one detector may communicate with the sensor wirelessly. In other embodiments, the at least one detector may be hardwired to the at least one sensor to facilitate communication. Multiple detectors may be provided to one or more locations of the cone, rotor housing sleeve, and/or water jacket, in various combinations or permutations, without limitation, and in some instances, at least one detector may be provided to one or more portions of each gravity concentrator within a system comprising multiple gravity concentrators (e.g., within a gold concentration plant). Moreover, at least one detector may be provided to one or more portions of a single gravity concentrator. For example, a first detector may be provided to a first portion of a cone or rotor housing shell, at a first radial location which is different than the radial location of a second detector provided to said cone or rotor housing shell. A second detector may be provided to a portion of a cone or rotor housing shell, at a second vertical location which is different than a first vertical location of a first detector. Various combinations of radially-displaced and vertically-displaced detectors within a cone of a gravity concentrator are envisaged. In having multiple detectors arranged along the same radial at a particular vertical position on the cone, it may be possible to indicate various extents of wear over time at the location of the radial (i.e., as wear proceeds along the radial).

A cone for use in a gravity concentrator is also disclosed. The cone may comprise a rotor housing shell attachment feature and at least one detector which may be configured to communicate with a sensor provided to the gravity concentrator. In use, portions of the at least one cone may wear away and ultimately affect a functionality of the least one detector. By virtue of communication with said sensor, in some embodiments, the at least one detector may aid in determining an operational status of the cone, and/or whether the operational status of the cone is within an acceptable range. By virtue of communication with the at least one detector, the at least one sensor may, in some embodiments, be configured to monitor said function of the least one detector and/or determine a real-time pressure profile at one or more regions of the water jacket.

In some embodiments, the at least one detector may comprise an RFID tag. In some embodiments, the at least one detector may comprise a magnet. In some embodiments, the at least one detector may comprise a wafer-style probe comprising a printed circuit board (PCB). In some embodiments, the at least one detector may comprise a radioisotope capable of emitting alpha particles and/or low energy gamma rays. Multiple detectors may be provided to the cone in any conceivable fashion or pattern, without limitation. For instance, in some embodiments, multiple detectors may be provided to different radial, vertical, or circumferential portions of a cone (e.g., to a cone skeletal frame, prior to casting). In certain embodiments, a detector may be provided to a cone as a separate component within a cavity, which may be pre-molded cavity or post-molding formed cavity. A threaded insert, cover plug, cover cap, and/or tapered cover plug may be utilized to capture a detector within said cavity. In other embodiments, detectors may be molded into a cavity provided within a cone, or more preferably affixed to a skeletal frame portions at predetermined locations and positions relative to the frame of a cone, prior to casting (e.g., prior to over-moulding the skeletal frame with a polymer such as urethane to form the cone).

### BRIEF DESCRIPTION OF THE DRAWING

To complement the description which is being made and for the purpose of aiding to better understand the features of the invention, a set of drawings is attached to the present specification as an integral part thereof, in which the following has been depicted with an illustrative and non-limiting character:

FIG. 1 is a schematic cross-sectional representation of a gravity concentrator employing certain non-limiting aspects of the invention, according to certain embodiments;

FIG. 2 is a schematic representation of a cone inner frame employing certain non-limiting aspects of the invention, according to certain embodiments;

FIG. 3 is a schematic representation of a cast cone (i.e., an over-molded cone inner frame) employing certain non-limiting aspects of the invention, according to certain embodiments;

FIG. 4 is a schematic cross-sectional representation of the cone of FIG. 3, showing certain non-limiting aspects of the invention, according to certain embodiments;

FIG. 5 is a photographic representation of an outer portion of a concentrator cast cone liner, schematically showing a direction of fluidization holes and spin direction of the cast cone liner and potential mounting/embedding points for one or more detectors according to some embodiments.

FIG. 6 is an isometric cross-sectional representation of the cast cone liner shown in FIGS. 3-5, further showing an inner portion of the liner having a series of fluidization holes therethrough, which pass from an outer area of the cone (i.e., adjacent a water jacket), to an inner portion of the cone, adjacent a trough/valley region.

FIGS. 7 and 8 are schematic cross-sectional representations of a cone assembly according to some embodiments, which further show how various pressures can be measured according to some embodiments. In particular, the figures demonstrate how pressures at various locations of a water jacket (as well as pressure at the base of trough/valley regions) can be measured.

FIG. 9 shows a full cross-section of a cone assembly according to some embodiments, wherein a cone is nested within a rotor housing shell to form a water jacket therebetween; wherein a number of pressure transducers may be placed within or mounted to areas defining the water jacket on an inner portion of the rotor housing shell; wherein a number of pressure transducers may be placed within the water jacket on an outer portion of the cone—or embedded within an outer portion of the cone so as to be exposed to portions of the water jacket; and wherein a number of pressure transducers may be provided adjacent one or more a radially-inward portions of a cone liner of the rotor housing shell, for examples, within or adjacent to trough/valley portions of a cone liner.

FIG. 10 shows one exemplary circuit which may optionally combine both pressure and wear readings from separate detectors, according to some embodiments;

In the following, the invention will be described in more detail with reference to drawings in conjunction with exemplary embodiments.

### DETAILED DESCRIPTION OF THE INVENTION

The following description of the non-limiting embodiments shown in the drawings is merely exemplary in nature and is in no way intended to limit the inventions disclosed herein, their applications, or uses.

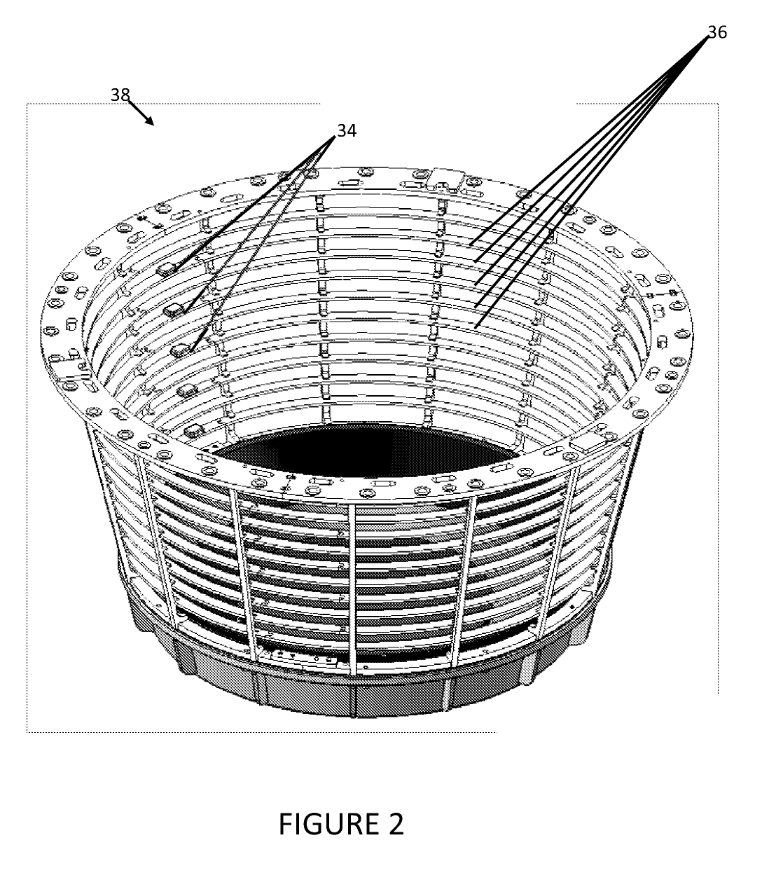

It is possible to monitor the wear of a gravity concentrator cone, through the application and use of technologies described in Applicant's co-pending International Patent Application No. PCT/EP2014/060342, which is hereby incorporated by reference in its entirety for any and all purposes as if fully set forth herein. Preferably, detectors (e.g., 433 MHz RFID tags) may be utilized in concert with gravity concentrator components and sensing apparatus. The detectors may, in some embodiments, be pre-arranged and positioned on a skeletal structure (i.e., frame 38), as shown in FIG. 2. Jigs or other fixtures may be use to precisely position the detectors at a preferred radial distance from the center of rotation of the frame, or at a particular vertical or circumferential location with respect thereto. In some embodiments, multiple detectors may be placed at different radial distances along a radial extending from an axis of rotation of the cone frame. In some embodiments, detectors may be spaced vertically, for example, in a direction parallel to an axis of rotation of the cone frame. Detectors may be distributed evenly or unevenly around a circumference of the cone frame, without limitation, but are preferably distributed in a way that sufficiently balances the finished cone. Adapters, such as pre-measured clips having a preset depth gauge, may be provided and pre-affixed to the detectors, and in this regard, the detectors may be clipped to a portion (e.g., a “rib” portion) of a cone frame, and urged radially inwardly or radially-outwardly until the preset depth gauge of the adapter “bottoms out” against said portion of the frame, as described in the aforementioned incorporated PCT/EP2014/060342 application. In this regard, adapters can reasonably assure proper placement of detectors within the cone after the cone is casted or poured (i.e., after the frame is placed in a chamber that is filled with polyurethane). Markings on the frame and/or adhesives or straps may be employed to temporarily secure detectors to the frame prior to and/or during molding/casting.

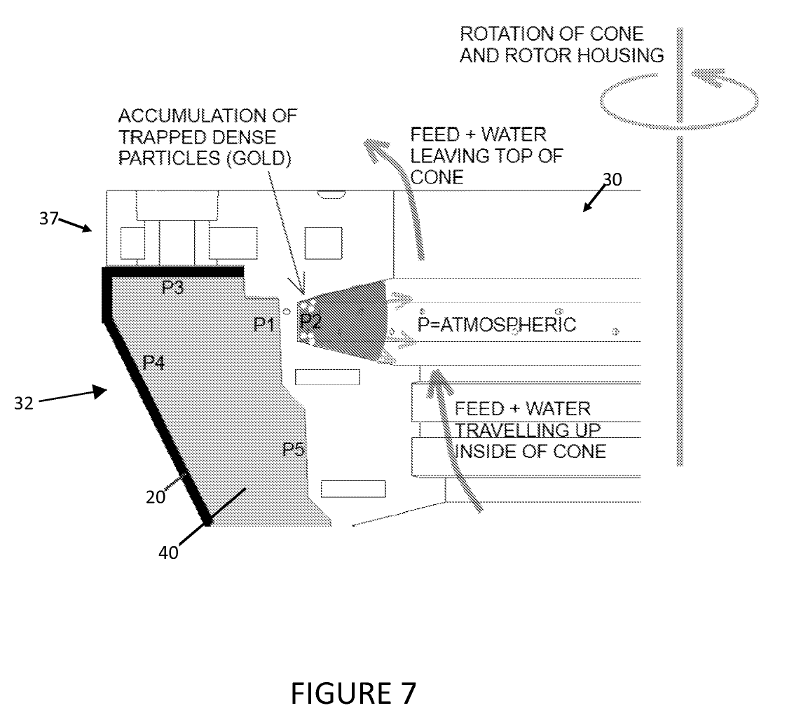

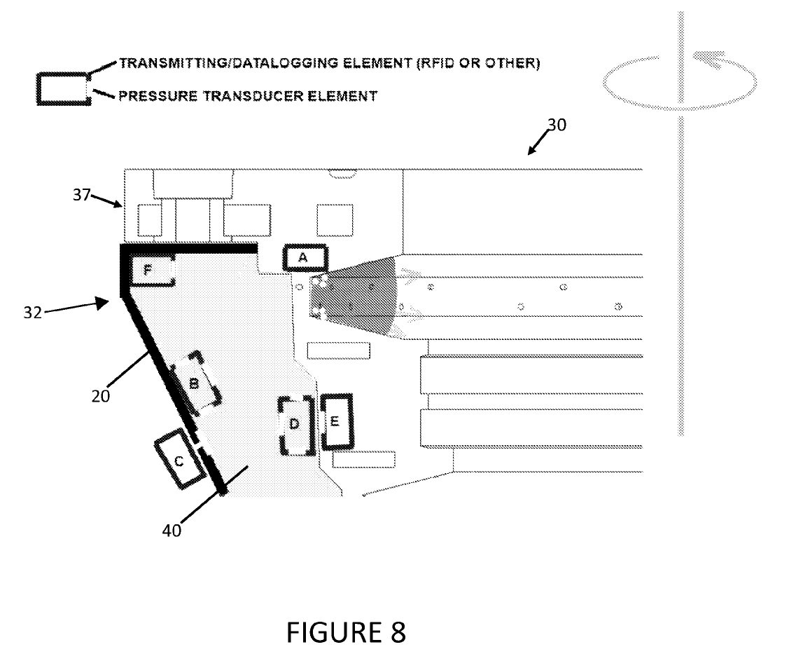

In some instances, in addition to, or in lieu of wear monitoring, periodic or continuous real-time pressure monitoring may be accomplished by virtue of one or more detectors comprising pressure transducers. For example, in some embodiments, one or more 433 MHz active (battery powered) RFID tags could be used to transmit pressure readings from a small pressure transducer, to a sensor positioned proximally above the cone. In this regard, sensors may be able to determine if there is significant blockage of one or more fluidization holes provided within the cone. If pressure exceeds a predetermined pressure threshold, it may indicate fluidization hole occlusion or a large presence of heavy target material (e.g., “gold”) filling the concentrator ring troughs (refer to FIGS. 7 and 8) and therefore, indicate when the cycle run time is near completion. For example, if pressure indicated by a particular detector exceeds or falls below a predetermined pressure threshold, and sensor information received by the controller CPU of the gravity concentrator reflects the same, the controller CPC may stop, slow, or terminate a run cycle of the gravity concentrator.

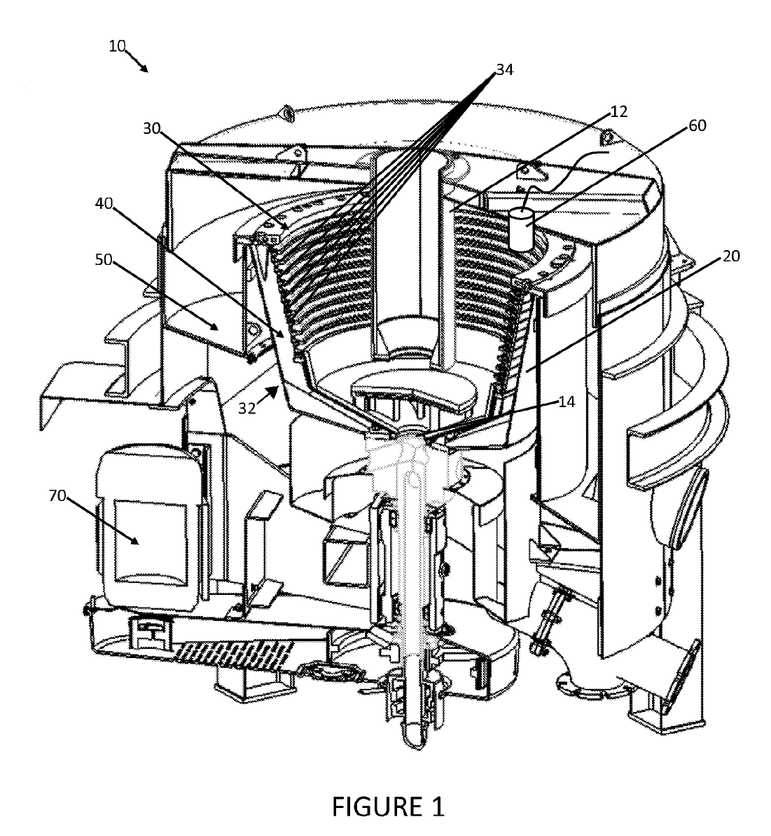

Turning to FIG. 1, a gravity concentrator 10 employing one or more detectors 34, and at least one sensor 60 is shown in cross-section. A number of detectors 34, which may comprise RFID tags, may be cast inside or inserted within one or more portions of a cone 30. In some preferred embodiments, the cone 30 may be made of a mildly soft to hard polyurethane. One or more sensors 60 may be positioned at a location relative to the gravity concentrator 10, for example, a location which is proximate the cone 30 and which preferably has a fairly direct line-of-sight (LOS) with the one or more detectors 34. The at least one sensor 60 may comprise a mountable or hand-held reader comprising an RFID antenna, without limitation. The antenna may be encapsulated, for example, in a protective urethane sheath and placed into a panel of the gravity concentrator frame, casing, or outer protective shell housing, without limitation. Placement may vary according to design, but it is anticipated that some best modes might include placement on or around a top panel of the gravity concentrator 10 as shown. A controller (e.g., programmable logic controller PLC), printed circuit board PCB, or CPU may communicate with the sensor 60 to enable various gravity concentrator 10 functions (e.g., on/off, faster/slower, next cycle, stop cycle, etc.), to be performed in an automated fashion, depending on input. The path extending between the one or more detectors and the sensor 60 is preferably free of any major components which may degrade, significantly attenuate, or cut off, signal transmissions between the sensor and one or more detectors. The cone base diameter, in some embodiments, may be approximately 1-5 feet in diameter, for example, may be around 34″, without limitation. The top/wide upper cone diameter, in some embodiments, may be approximately 2-6 feet in diameter, for example, may be around 48″, without limitation. In some preferred embodiments, cone RPM during operation may range between approximately 0 to approximately 460, without limitation.

Slurry enters an upper central feed port 12 (i.e., “feed entry point”), and is distributed radially-outwardly and upwardly via centrifugal forces and by virtue of an internal outward taper of the cone 30. The specific gravity of the incoming slurry may contain ore concentrates having a specific gravity near or approximately 3.0. Lower density particles within the incoming feed migrate radially-inwardly as the incoming feed moves toward a lower density feed discharge. Heavier, denser target materials (e.g., gold) move radially-outwardly as incoming feed moves toward the lower density feed discharge 50, and get trapped in “concentrator rings”. Upon stopping the concentrator, the heavier, denser target materials which are trapped in the troughed portions 33 of the concentrator rings, are gathered and removed by a central concentrate discharge 14. A pressurized water jacket 40 is formed behind the cone 30, between an outer surface 39 of the cone 30, and a rotor housing shell 20. Water within the pressurized water jacket 40 may be forced radially-inwardly through fluidization holes in the cone 30, to fluidize the slurry and unbind trapped low-density particles from the denser target materials.

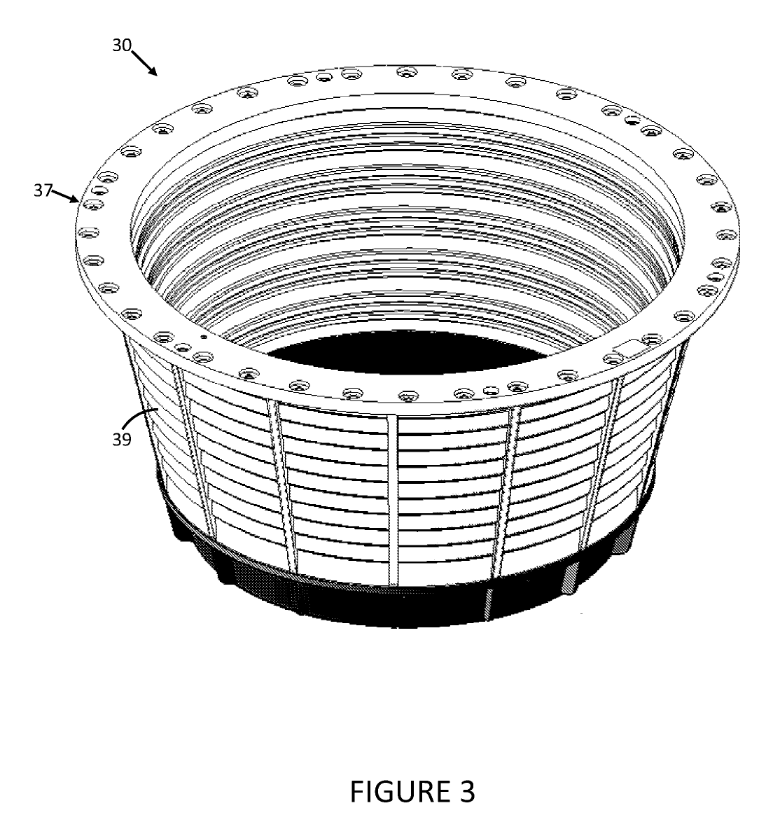

FIG. 2 is a schematic representation of a pre-cast cone frame 38 employing certain non-limiting aspects of the invention, according to certain embodiments. A frame 38 is provided, and a number of detectors 34 may be placed at predetermined locations of the frame 38, for example, placed and/or affixed to a number of frame structural members 36. The number of detectors 34 may be fastened to the frame via an adapter, such as a clip, adhesive, interference, or other male/female connection. An adapter (not shown) or a portion of a detector 34 may have a geometry which complements the frame 38, such that the relative radial position of said detector 34 with respect to a central axis of the cone 30 can be controlled, or accurately or precisely set, prior to pouring urethane or other casting material over the frame 38. FIG. 3 is a schematic representation of a post-cast cone 30 (i.e., an over-molded cone frame 38) employing certain non-limiting aspects of the invention, according to certain embodiments. The detectors embedded there within are not shown for clarity.

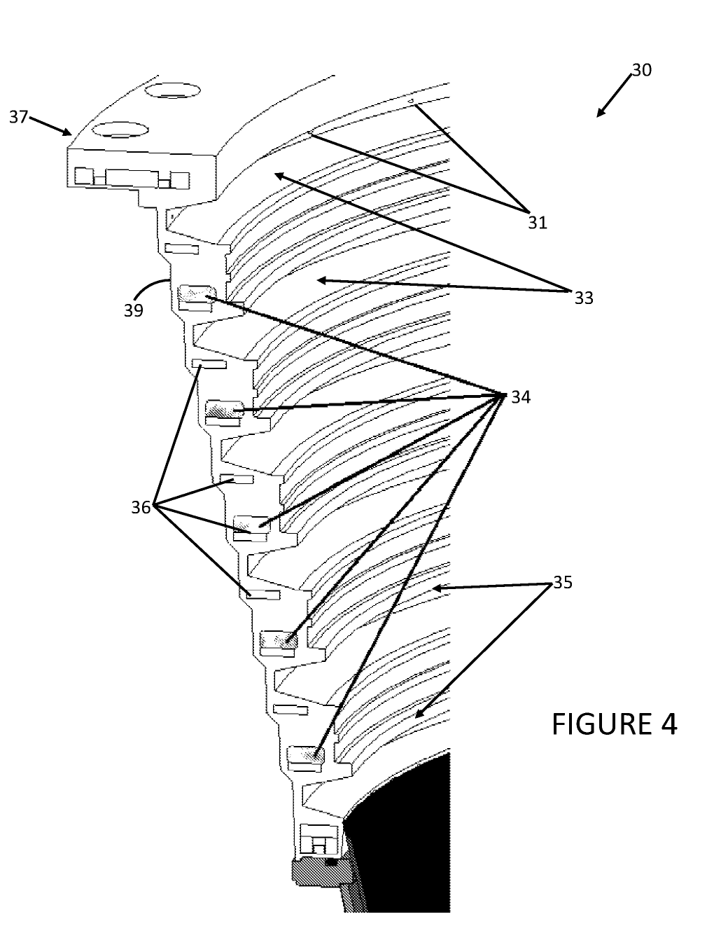

FIG. 4 is a schematic cross-sectional representation of the casted cone of FIG. 3, showing certain non-limiting aspects of the invention, according to certain embodiments. As shown in more clarity, cone 30 may comprise a flange 37 and cone section comprising a frame 38 comprised of a plurality of ribs and a molded body there over, the molded body preferably comprising a urethane, an outer face 39, and an inner face. The inner face may comprise concentrator rings, the concentrator rings comprised of troughs 33 and peaks and/or ridges 35 interposed between the troughs 33, and one or more detectors 34 encased therewithin. Within one or more of the troughs 33, a number of fluidization holes 31 may be provided.

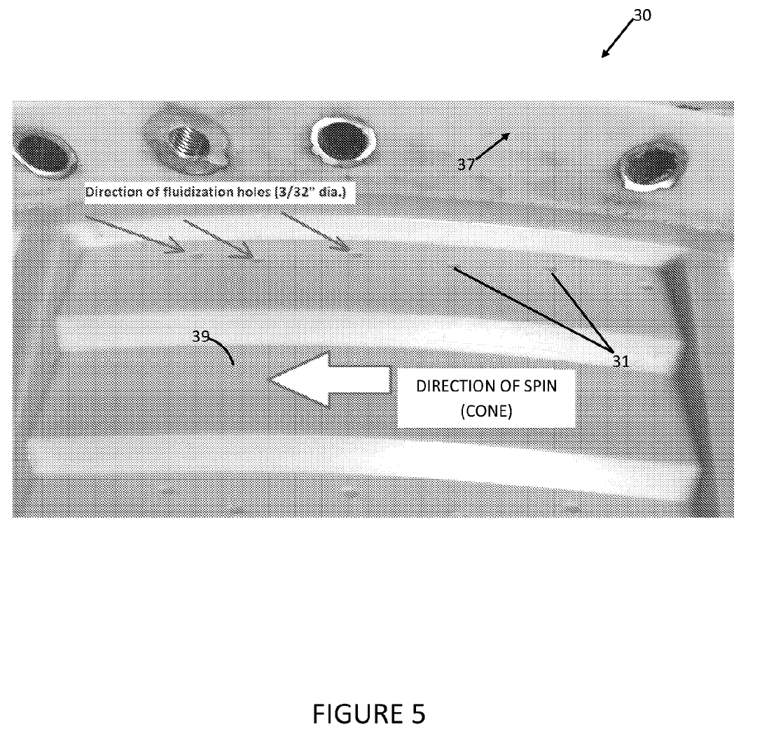

FIG. 5 is a photographic representation of an outer portion of a concentrator cast cone liner, schematically showing an angled direction of fluidization holes 31 and a direction of spin/rotation of the cast cone 30. The photograph also depicts the lower portion of the upper flange 37 which form an upper portion of water jacket 40.

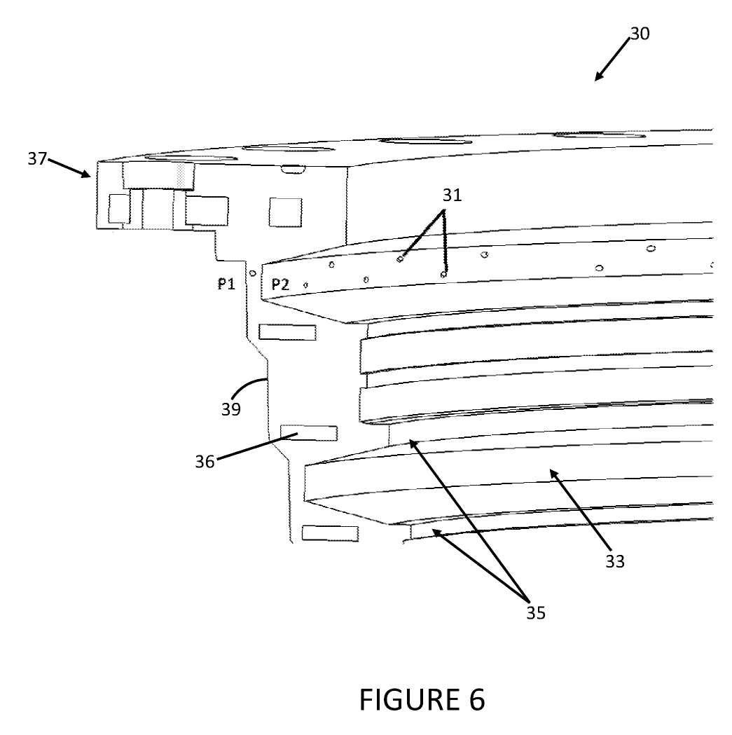

FIG. 6 is an isometric cross-sectional representation of the cast cone liner shown in FIGS. 3-5, further showing an inner portion of the liner having a series of fluidization holes therethrough.

FIGS. 7 and 8 are schematic cross-sectional representations of a cast cone liner according to some embodiments, further showing how various pressures can be measured according to some embodiments. As can be appreciated from the figures, as the cone turns, slurry deposited into the bottom central portion of the cone 30 travels radially outward (e.g., at between approximately 30 and 90 G's, and more preferably, between approximately 50 and 70 G's, for example, 60 G's) and upwardly, over the flange 37 of the cone assembly 32. Heavier material within the slurry (e.g., gold) becomes trapped in the troughs/valleys 33 of the cone 30, whereas lighter particle elements within the incoming slurry feed pass over peaks/ridges 35 and over flange 37, and into launder 50. As shown in FIG. 8, one or more pressure transducer detectors (e.g., labeled “C” in FIG. 8) may be exteriorly mounted to the rotor housing shell 20, for example, so long as a portion of the detector C is exposed to the water jacket 40. Moreover, as shown in FIG. 8, one or more pressure transducer detectors (e.g., labeled “A” and “E” in FIG. 8) may be partially or nearly fully embedded within the cone 30, for example, so long as a portion of the detectors A, E are exposed to the water jacket 40. While not explicitly shown, one or more portions of one or more detectors (e.g., detector “A”) may be exposed to a portion of a trough/valley 33 to monitor fluidization pressures from water exiting water jacket 40 and entering said trough/valley 33. In this regard, it can be readily ascertained whether or not there is sufficient fluidization for ensuring that trapped gangue particles are gently agitated and migrated from said trough/valley 33, without disrupting or dislodging trapped value particles (e.g., heavier gold particles) from the trough/valley 33.

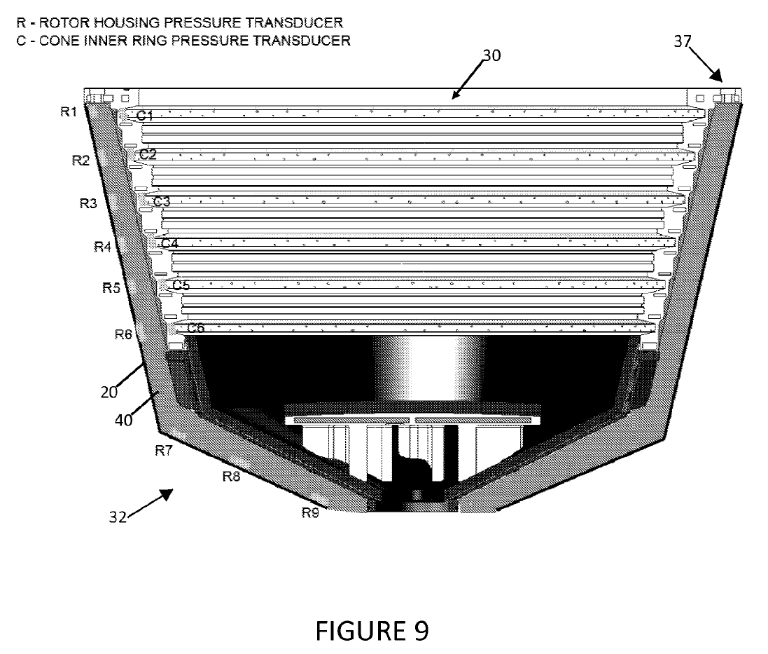

FIG. 9 shows a cone nested within a rotor housing shell, with a water jacket therebetween; wherein a number of pressure transducers may be placed within the water jacket on an inner portion of the rotor housing shell, and/or wherein a number of pressure transducers may be provided adjacent one or more a radially-inward portions of a cone liner of the rotor housing shell, for examples, within troughs of a cone liner.

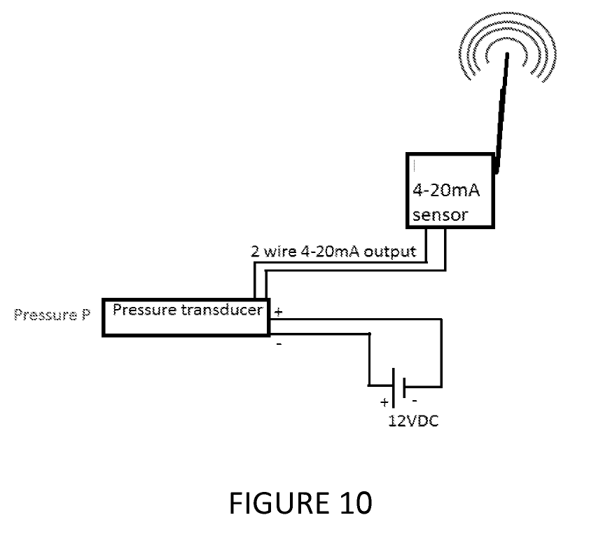

As one particular non-limiting example, a detector may be configured to provide pressure information, according to some embodiments. As another particular non-limiting example, a detector may be configured to provide wear information, according to some embodiments. As yet another particular non-limiting example, a detector may be configured to provide both pressure information and wear information, according to some embodiments. A detector may comprise, for instance, a 0-100 psi liquid pressure transducer, for example, having 4-20 mA outputs, without limitation. A detector may comprise, for instance, a 433 MHz transmitter that relays a 4-20 mA input to an external receiver, without limitation. In some preferred embodiments, a detector may comprise an RFID detector, without limitation. One or more sensors could, in some embodiments, be used to establish a non-pressure related water jacket profile. FIG. 10 shows one exemplary circuit which may combine both pressure and wear readings from separate detectors, according to some embodiments.

According to some embodiments, one or more detectors and/or a sensor comprising a reader/data logger may be employed. For example, the one or more detectors and/or a reader/data logger may utilize or comprise portions of a Tire Pressure Monitoring System (TPMS) which may be advantageously employed to determine a pressure profile within the water jacket 40. The pressure profile information may be compared against a standard water jacket pressure profile, and one or more operating parameters of the gravity concentrator/centrifugal separator 10 may be adjusted to optimize performance and recovery.

While not shown, a cone 30 may be provided with one or more detectors 34 such as first detectors, second detectors, and/or third detectors. One or more complimentary sensors 60 which are provided to the housing or other portion of the gravity concentrator 10 monitor a status of the one or more first, second, or third detectors, and deliver information (e.g., via a network) to a control system incorporating a PLC unit. In operation, if/when one or more of the detectors 34 fail due to excessive wearing of portions of the cone 30, the one or more sensors 60 may indicate that maintenance may be necessary, and/or may prompt an operator to slow or stop the gravity concentrator 10 by reducing current to the drive motor 70, and/or may automatically slow or stop the gravity concentrator 10 by reducing current to the drive motor 70 via a control system comprising a CPU provided with hardware, memory, and software comprising algorithms and logic expressions.

The exact number and particular placement of the detectors 34 within the cone may vary depending on how much wear information is preferred or to what extent control adjustments may be necessary. In some embodiments, two or three detectors may be placed at a similar axial location and different radial location within the cone 30, to monitor extent of wear, over time, at a particular cone location. In some embodiments, multiple detectors 34 may be placed at various vertical locations along a direction of an axis of the cone, to show an extent of wear in certain locations, relative to other locations (e.g., wear adjacent/towards a bottom cone portion, vs. wear adjacent/towards a middle cone portion, vs. wear adjacent/towards a near top rim cone portion). One sensor 60 may be provided to monitor each detector 34, or a sensor 60 may monitor more than one detector 34. In such embodiments, each of the one or more sensors 60 may monitor and provide, in real-time and during operation, an in-situ wear profile of a cone, without stopping, dismantling, or visually inspecting portions of a gravity concentrator.

In some embodiments, the detectors 34 may comprise RFID (including LF and UHF tags) which are cast into or otherwise provided within polyurethane at a preset radial depth from an innermost radial profile of the cone 30, or cone feature, such as a concentrator ring comprised of a trough 33 and peak or ridge 35. In other embodiments, the detectors 34 may comprise magnets which are cast into or otherwise provided within polyurethane at a preset radial depth from an innermost radial profile of the cone. Sensors 60 described herein may comprise an RFID reader/interrogator's antenna or a Hall Effect sensor (in instances where the detectors 34 are configured as magnets). For example, in some instances, a sensor 60 may comprise a printed circuit board which is operatively connected to an RFID reader/interrogator antenna that transmits signals to and receives signals from a detector 34 comprising an RFID tag. The sensor 60 may further comprise a cable connecting the printed circuit board to the antennae which is positioned at some distance away from the printed circuit board. During the operation of the gravity concentrator 10, the sensor 60 provided to the concentrator 10 (whether outside the housing or embedded within the housing), detects the spinning detectors 34 embedded in the cone 30. As the cone 30 wear down, its material recedes/erodes, its inner diameters grow, and its walls thin down. Eventually, at some point during operation, some detectors 34 may be sacrificially consumed, at which point one or more signals provided by the detectors 30 to the sensor(s) 60 (and ultimately to the control system) may be altered or no longer generated. Such changes in signaling may indicate that one or more portions of a cone 30, or the entirety of the cone 30, itself, may have worn past one or more certain predetermined amounts. Information regarding wear rates and current wear status of the cone 30 may be relayed from the sensor(s) 60 to a control system reflecting the same in real-time—without any need to stop the operation, remove contents of the concentrator 10, or gain physical access for visual inspection. Visual warnings such as lights (green-OK, orange-Standby, red-Caution) or audible warnings such as sirens, horns, or sound-emitting diodes may be activated to alert operators of the status of the concentrator 10 or components thereof. Indicators implying to cease operation of the concentrator 10, modify certain operational parameters (RPM, power, or run time) of the concentrator 10, or replace or refurbish the cone 30 prior to excessive cone wear/failure may be provided in any conceivable fashion.

According to some embodiments, as shown, a single sensor 60 may be optionally employed to one or more housing and/or frame portions of the concentrator 10. In some embodiments (not shown), one or more sensors 60 may be placed on one or both end portions of the housing of the concentrator, such that detectors 34 are always within a general line-of-sight generally along or substantially parallel to an axis of rotation of the cone. In this regard, sensors 60 may be able to detect the existence of detectors 34 without significant intermittent interruption. Such end-mounted sensors 60 may be circular or ring-shaped—or otherwise may be arranged in ring formations to better track the annular paths of detectors 34 as they rotate about the axis of rotation of the cone and rotor housing shell assembly. Antennas associated with sensors 60 may be oriented generally horizontally, generally vertically, and/or generally diagonally, without limitation. Sensors 60 may be provided to a concentrator 10 in any number or configuration. Sensors 60 may comprise the capability to monitor various different RFID or UHFID frequencies, and the detectors 34 may comprise different transponders which resonate/signal at different frequencies. In some cases, all detectors 34 at a first location of a cone 30 may comprise a similar first operational frequency, and all detectors 34 at another second location of a cone 30 may comprise a similar second operational frequency which is different from the first operational frequency. In other cases, all detectors 34 may operate on the same frequency, and a sensor(s) 60 may identify each detector 34 based on its own unique identification (UID). For instance, detectors 34 may comprise unique RFID tags, and a sensor(s) 60 may comprise a reader/interrogator and antennae tuned to a specific carrier frequency which may read the RFID tags which are tuned to said specific carrier frequency. In such instances, multiple carrier frequencies between cone locations may not be employed. In certain embodiments, detectors 34 which are located further from the sensor(s) 60 may operate on higher frequencies than detectors 34 which are located closer to the sensor(s) 60 (or vice-versa), in order to improve range or mitigate interference. In further non-limiting embodiments, all radially-innermost detectors 34 may operate on a first frequency, all radially-outermost detectors 34 may operate on a third frequency, and all centrally-disposed detectors within the cone 30 may operate on a second frequency, wherein each of the first, second, and third frequencies may be different from each other.

Alternatively, while not shown, in addition to one or more of the mounted or hard-wired sensors 60, handheld sensors (such as one or more handheld RFID readers) may optionally be employed. In such embodiments, an operator of a gravity concentrator 10 may periodically check cone 30 statuses on the go, or use a single reader between different remotely-located gravity concentrators 10 which employ the devices disclosed herein. The handheld readers may incorporate necessary hardware and appropriate software to properly communicate with the one or more detectors 34.

### Example 1

According to one possible example of a time lapse wear scenario for a particular cone 30 within a gravity concentrator 10, a cone 30 may initially comprise three detectors—each operating at different RFID or UHFID frequencies. In use, a nearby sensor 60 provided in the form of an RFID or UHFID reader/interrogator may produce a first check signal, a second check signal, and a third check signal. While the cone 30 spins, the detectors 34 may pass by the sensor 60 and reflect first, second, and third confirmation signals, respectively. In some instances, during ideal operating conditions, all three detectors may be fully-operational and therefore produce all three of the confirmation signals. In these instances, the sensor 60 may relay an OK status to the control system for the gravity concentrator 10.

In the same example, a radially-innermost first detector may be consumed in whole or part by wear, and consequently may be sent to launder 50 with the slurry in the cone 30 via gravitational forces and low relative density. In this instance, the radially-innermost first detector may lose its functionality and therefore may not respond to the first check signal. Accordingly, the radially-innermost first detector may not produce a first confirmation signal to the sensor 60, and the sensor 60 may convey this information to the control system, wherein a caution flag may be issued.

Moreover, both the radially-innermost first detector and the middle second detector may be consumed by wear. In this instance, the middle second detector may also lose its functionality and therefore, may not respond to a second check signal. Accordingly, only the innermost third detector may produce a third confirmation signal to the sensor 60. With no first or second confirmation signals being received by the sensor 60, and only one third confirmation signal being received by the sensor 60, a warning flag may be issued. Caution/warning flags may comprise the delivery of acoustic or visual stimuli to the machine operator (e.g., via siren or colored lights), or they may comprise the delivery of electronic signals from the sensor 60 to a programmable logic controller (PLC) or central processing unit (CPU) in the control system (e.g., PID controller) which controls the operation of the gravity concentrator 10. In such an instance where all of the first, second, and third detectors 34 have been consumed by wear, none of the first, second, or third confirmation signals may be received by the sensor 60, and a warning flag indicating that maintenance is required may be issued.

In some embodiments, a vertical location along a height or rotational axis of cone 30 may comprise only a single detector 34. For example, in some embodiments, each vertical location of cone 30 may comprise only a single detector 34. It may be preferable to locate the radial position of the detector 34 differently, depending on its vertical position, relative to the cone 30. For example, the radial position of a detector 34 within a particular cone 30 (e.g., with respect to a distance from an inner surface of cone 30) may be a function of how fast said particular cone 30 typically wears out. Or, a radial position of a detector 34 within a particular cone 30 may be determined as a function of where said particular cone 30 experiences most wear, or soonest wear. In another example, a position of a detector 34 within a particular cone 30 may change as a function of the detector's vertical position along a height or the axis of rotation of the cone—or may change as a function of the detector's vertical position in relation to a gravity concentrator 10 as a whole. For instance, in a non-limiting example, if one or more lower or upper cone portions 30 might be more prone to wear, then the one or more lower or upper cone portions 30 may each be provided with a detector 34 which is located more radially-outwardly and/or further from the axis of rotation of the cone 30, than a detector 34 which is provided in an area of a cone which is less susceptible to wear. Those skilled in the art would instantly recognize the benefits of configuring cones with ideal detector locations, or strategically positioning detectors within a cone, based upon known cone wear patterns and maximum wear thresholds for particular locations of a cone 30.

A sensor 60 may comprise an RFID or UHFID reader/interrogator which can operate on multiple frequencies. A first check signal, a second check signal, a third check signal, a fourth check signal, and a fifth check signal may be produced (e.g., by a single sensor 60). A first portion of the cone 30 may be outfitted with a detector 34 capable of operating on the same frequency as the first check signal; a second portion of the cone 30 may be outfitted with a detector 34 capable of operating on the same frequency as the second check signal; a third portion of the cone 30 may be outfitted with a detector 34 capable of operating on the same frequency as the third check signal; a fourth portion of the cone 30 may be outfitted with a detector 34 capable of operating on the same frequency as the fourth check signal; and, a fifth portion of the cone 30 may be outfitted with a detector 34 capable of operating on the same frequency as the fifth check signal.

In the case of sacrificial wear detectors, if a detector 34 on a first portion of the cone 30 is worn away, dislodged, or damaged, it may not produce a first confirmation signal or an equivalent response to the sensor 60. Therefore, a control system operatively communicating with the sensor and/or detector might be informed that the first portion of the cone 30 has worn past a predetermined wear threshold and may need replacement, and/or an operator would be alerted of the same via audio stimuli, visual stimuli, or electronic communication, without limitation. In such an instance, the remaining detectors 34 in the second through fifth portions of the cone 30 may still provide second, third, fourth, and fifth confirmation signals, respectively. If this is the case, a control system may report a status of each of the second, third, fourth, and fifth detectors 34 as being fully operational. In the same example, if non-sacrificial or measuring wear detectors are used (e.g., those comprising a printed circuit board (PCB) or replaceable expendable measuring probe wear element), as portions of the detector 34 at the first portion of the cone 30 are worn away or damaged, it may produce an altered first confirmation signal. Data pertaining to changes in the first confirmation signal may be measured, recorded, and processed by the sensor 60 and/or control system to indicate to an operator, an approximate amount of wear that has occurred at the first portion of the cone. Indications of operational status may be provided through a graphical user interface, mobile application, push notification, or lighted control panel, without limitation.

Various non-limiting methods of embedding a detector 34 in a cone 30 may be used, without limitation, as suggested in co-pending FIGS. 5-9B of PCT/EP2014/060342. For example, a threaded insert having a cavity therein may be threaded into a threaded receiving portion provided in an outer surface 39 of a pre-cast polyurethane cone 30, in order to capture a detector 34 therein. Alternatively, a detector 34 may be placed into a cavity within a pre-cast polyurethane cone 30, and a cover plug may be placed over it and glued, welded, or otherwise bonded to the rest of the polyurethane cone 30. While not shown, the cover plug may incorporate several separate snap fit features to secure itself to complimentary mating snap fit features on the pre-cast polyurethane cone 30, or the cover plug, itself, may comprise a monolithic snap-fit fastener which complimentarily mates with features provided in the cone 30. Moreover, portions of the cone 30 surrounding the cover plug, or portions of the cover plug may comprise surface textures, grooves, channels, or protuberances for improved friction or to allow ingress of bonding means such as an adhesive or seam repair. Even more alternatively, a detector 34 may be embedded in a cavity of, co-molded with, or cast into polymer cone material (e.g., polyurethane) to form a casted cone 30. Furthermore, in some embodiments, a cover cap may be placed over a cavity in a cone 30 in order to capture and pot a detector 34 therein. The cover cap may be provided with at least one aperture configured to receive and retain fastening means which engages at least one threaded receiving portion provided to the pre-cast cone 30.

In some embodiments, a detector 34 may be placed into a cavity within a molded cone, and a tapered cover plug may be placed over it and glued, welded, or otherwise bonded to the rest of the cone 30 with bonding means. The tapered cover plug or surrounding portions of the cone 30 may be textured for improved friction or to provide bonding means with larger contact surface area. In other embodiments, the detector 34 may be placed into a tapered plug and press-fit, glued, friction welded, or otherwise bonded to the rest of the cone 30 with bonding means. Furthermore, while not shown, channels or protuberances may be provided on outer surfaces of a tapered cover plug to allow ingress of bonding and/or potting means for an embedded detector 34. In some embodiments, a detector 34 may be pre-molded or potted into a plug subassembly which may then be placed, secured to, or otherwise positioned with frame 38, and into a mold, and then over-molded to form a complete cone 30. In some embodiments, a detector 34 may be placed with a frame 38 prior to over-moulding without the benefit of potting or a housing. Alternatively, a cavity may be pre-formed within a molded cone 30, the cavity being a blind or through hole. The pre-molded plug may be positioned into the cavity by interference fit, adhesive, weld, over molding, threading between the pre-molded plug and the cavity, or other mechanical fastening means. Detectors 34 may be arranged in various circumferential patterns and/or spacings throughout a cone 30, and do not necessarily require radial alignment along a single radial of the cone.

Fastening means known in the art may be used to secure detectors 34 to the rotor shell housing 20 or to the structural skeletal frame 38 of the cone. The fastening means may comprise any known devices for connecting two components, including, but not limited to, hardware (bolts, nuts, washers, locking washers), welds, snap-fits, clips, zip ties, interference fits, flexible grommets, snap fits, or adhesive without limitation

Embodiments may include a process of refurbishing a used cone 30 comprising the steps of: removing outer worn portions (e.g., of polymeric material) from its frame 38, cleaning the frame 38 to re-purpose it, attaching new detectors 34 to the cleaned/re-purposed frame 38, and re-casting a new cone 30 with the new detectors 34 by placing the cleaned/re-purposed frame 38 and new detectors 34 into a mold, and overmoulding the assembly to form a new cone 30. For instance, a metallic frame 38 of a used cone 30 may be completely removed and subjected to water blasting, grit blasting, or burn-off to remove residual outer portions of the cone 30 from frame structural members 36; wherein the outer portions may comprise a urethane. The removal process may be followed by a re-casting step, wherein the frame 38 is covered with a new outer portion to form a completed refurbished/remanufactured cone 30. During or after the re-casting step, one or more detectors 34 may be deposited within the cone's polymer outer portion (e.g., polymer or urethane layer). Cone resurfacing processes are also envisaged, wherein inner and/or outer surfaces of a cone are “re-molded”, similar to how tires are re-treaded. In such embodiments, a used cone may be refurbished by: machining down worn sections of the cone 30 to remove the worn sections, attaching or embedding new detectors 34 to portions of the machined down cone, and then placing the assembly in a mold and overmoulding the assembly to receive new cone surfaces, without limitation.

According to yet other embodiments, detectors 34 may be configured to work with a sensor 60 that is provided within a shaft of the rotor housing shell or cone assembly, or otherwise operatively-connected to a rotating shaft (e.g., provided within water jacket 40). Accordingly, data may be received from a detector 34 without interruption from intermittent tangential passes with each orbit of the detector 34 with respect to other components of the concentrator 10. In such cases, a cone 30 may be comprised of a wafer-style wear detector having a printed circuit board. As the wafer-style wear detector erodes, electrical paths flowing through the printed circuit board change; thereby changing a signal to a sensor 60 and/or a gravity concentrator controller. A wire extending from the wear detector 34 may communicate with a sensor 60 and/or gravity controller (not shown) via a wireless, or hard-wired connection.

For example, a cone 30 may comprise a probe-style wear detector having a series of parallel circuits, to which a known voltage is applied. The probe-style wear detector may be placed within a cone 30 at a predetermined spaced distance from an inner when the cone 30 is new or newly re-manufactured. In use, as wear on the cone 30 progresses, no measurable changes may be detected by the detector, since the current in each of the parallel circuits remains the same. Accordingly, a sensor 60 operatively connected to or operatively communicating with the detector (whether wireless or via a wired connection), may not indicate a change in operational status to a control system and/or would not trip an alarm. However, as wear progresses further, outer portions of the detector may begin to erode away, disrupting outer-most parallel circuits within the detector. This, in turn, may cause currents in the remaining parallel circuits of the detector to change. As wear continues even further, the current through each remaining intact parallel circuit may substantially increase until it exceeds a preset threshold or the detector ceases to function properly at all—at which point maximum recommended wear has likely been realized, and an alarm for the respective detector would preferably be tripped. The selected preset threshold should be indicative of a proper time to replace/refurbish the cone 30, based upon its performance specifications, its maximum or minimum operational ranges or operating tolerances, as a function of deviation from inner radial dimensions or profiles when new, and/or engineering requirements. When selecting a preset threshold, careful consideration should be given to achieve maximum use life of a cone 30 without negatively affecting efficiency or prematurely limiting its useful life.

In some embodiments, both wafer-style and probe-style detectors may be comprised of specialized very-thin printed circuit boards (PCBs) which may be waterproof to IP 68 and may operate at temperatures between −20° and +80° C. A power supply (e.g., 12 VDC with a 20 mA maximum current) may be employed to power the detectors directly, or the detectors may be powered indirectly via a serial bus with the sensor, control system, or network. Other voltages and currents are envisaged, depending on the specifications of the particular detector being used. In some instances, power may be supplied to the detectors via a combined power & data cable which connects to a sensor 60, control system, or network. Alternatively, the detectors 34 may be stand-alone battery-operated devices that communicate with a sensor, control system, or network via ZigBee® wireless standards (802.15.4), or other wireless protocol (e.g., an IEEE 802.11-based standard). Portions of the sensor 60, control system, or network may be provided within a rotating shaft of the gravity concentrator 10, or otherwise operatively-connected to a rotating shaft via a brush-type contact or similar arrangement commonly used in electric motors. Moreover, portions of the sensor 60, control system, or network may be provided within or to inner or outer portions of the concentrator housing, rotor housing shell, and/or cone 30 assembly, without limitation. For example, one or more portions of the sensor 60 may be located within water jacket 40, without limitation.

As eluded to earlier, a human machine interface (HMI) computer may be provided to serve as the gateway between the detector/sensor hardware and larger concentrator circuit/plant operations. The HMI computer may have shared or multiple network interfaces—for instance, at least one interface for a dedicated concentrator cone wear-monitoring or pressure-monitoring network, and at least one interface for the entire concentrating network. Alternatively, the HMI computer for cone wear monitoring may run completely independently of any concentrating circuit/plant network. One or more software components may be installed on the HMI computer which will allow it to perform all the necessary functions for display, analysis, and alarm management, as well as data reporting and historian functions. Input processing may be facilitated by “unsolicited” transmissions from each sensor 60 with data corresponding to detectors 34, and therefore, each sensor 60 may have its own unique Ethernet (IP) address and may communicate via a dedicated Ethernet network to the HMI computer/control room PC. Data may be retrieved from the detectors 34 and accumulated in each sensor 60 until a set interval, at which point the sensor 60 may send a block of data to the HMI computer/control room PC. Software on the HMI computer or control room PC may intercept the block of data, and “unpack” it into OPC tags which can be made available to all other internal and external users. Data points stored in the OPC tags may be configurable, and can be logged to a SQL database for future analysis. A data historian and analysis console may be made available for the review of past cone wear performance or historical pressure curve information. With such a console, data may be compared visually in a large number of different two-dimensional and/or three-dimensional charts and graphs. Data may also be provided in its raw format, for viewing and copying for export to other programs. Data can be retrieved for one or many detectors 34, sensors 60, gravity concentrators 10, hardware units, or concentrating circuits. In some embodiments, the time period of the aforementioned interval can be selected, from a few minutes to as long as the system has been in operation, provided there is adequate hard drive space for the data. An alarm manager may also be provided if customized and detailed alarm control is desired from the HMI computer. For example, a “basic” alarm mode may be provided as a default, wherein a visual display client (not shown) shows various portions of a schematic cone assembly changing colors from green, to yellow, to red (including colors therebetween or additional colors, without limitation), depending on the condition of the detectors therein. Numbers may be employed, wherein for example, 100% might indicate no wear, and 50% might indicate half-life, and 0% might indicate a maximum allowable amount of wear. Levels and thresholds may be preselected and defined during system configuration, may be adjusted during operation, or may be re-set to default (e.g., upon re-commissioning). Advanced alarm management may also be provided, wherein once active, alarm conditions can be set with delays, escalations, or even sequences of conditions. Responses can vary from simple messages to external (e.g., email notification, pager notification, cell phone/text, etc.) communications.

Real-time data and system status may be displayed on the visual display client, which can be viewed from the HMI computer, or from any other CPU on the plant's network which can access the OPC data on the HMI computer. The visual display client may display plant-wide status views with color codes for overall concentrator circuit status, gravity concentrator status, cone status, pressure status, wear status, detector status, or sensor status. In some embodiments, any sensor 60 can be selected for individual viewing with a mouse click from within the visual display client. Sensor 60 views may show individual detector 34 readings for each portion or a specific portion of a cone 30, with colors, numbers, or other indicia indicating status and/or current or past performance (e.g., current and/or past wear rate, current wear amount, current cone inside diameter/radius, or expression of % life remaining, etc.). In addition, individual portions of a cone, or individual concentrator cones within a larger circuit comprising multiple concentrators 10, can be selected, using mouse clicks, to display detailed status information for those readings which are not normally displayed on other higher-level hierarchical views (such as the overall concentrator circuit operation views and/or gravity concentrator operation views).

A rolling graph may be displayed, which, in certain embodiments may show trends for up to 24 previous hours or more (e.g., past week or past month views). Communication services may be provided which output OPC tag values to, for example, a CHIP or PI system, or another OPC capable server. The tags can be individually selected for output, and the names of the tags on the target system can be specified for each tag. Alternately, an external OPC server capable of soliciting communications using OPC/DA can request the tag data from the HMI computer directly. OPC “Tunneling” programs, such as Matrikon, PI Tunneler, or OPC Mirror (provided by Emerson Process management), may further be used to establish secure links to the HMI computer in order to retrieve data.

In some embodiments, sensors 60 may collect and process data from the detectors 34 installed in the cone periodically (e.g., every 5 or 10 seconds, without limitation) and communicate the data to a controller (e.g., HMI computer) on its data bus. Depending on the type of detectors 34 used, sensors 60 may provide power, data acquisition, data processing, and configuration/optimization capabilities. Detector-to-sensor communication may be either cabled or wireless, with up to several detectors 34 (of various types) per sensor 60. In some non-limiting embodiments, sensors 60 may be housed in a factory-sealed polymeric box exceeding a UL94-HB flammability rating and means for mounting may be provided to the box for mounting to various components of a gravity concentrator 10, such as to a housing. In some non-limiting embodiments, sensors may hold up to NEMA 4X/IP 65 tests, operating temperatures from −20° to +60° C., and storage temperatures ranging between −40° C. and +80° C., without limitation. In some non-limiting embodiments, sensors may run on 12 or 24 VDC (0.2 Amp) isolated power supplied through a bus cable, without limitation. Sensor bus communications/data protocols may comprise an RS-485 multidrop network with 15 KV ESD and transient protection, without limitation. In some embodiments, shielded DeviceNet cables may connect sensors which may be provided to various portions of a concentrating circuit. Means may be provided to allow firmware to be field-upgraded using built-in bootload capability.

One or more sensors 60 may be provided to the shaft, rather than outer shell housing. Wireless RFID or UHFID communication can be made between one or more detectors 34 located on or within a cone 30, and the one or more sensors 60 as shown. Alternatively, hardwired connections may be optionally utilized. In some embodiments, wires may comprise shielded cables, waterproof cables, chemical tolerant cables, and/or abrasion-resistant cables which connect one or more detectors 34 to the more sensors 60 as shown. Brush and commutator, or other forms of motion-enabled conductive contact pairs may be utilized to maintain electrical contact between spinning detectors 34 and a power supply, sensor 60, or control system. For example, such contact pairs may be made between the rotor housing shell 20 and an internal portion of the gravity concentrator/centrifugal separator 10 (e.g., adjacent a drive shaft or bearing housing). As another example, such contact pairs may be made between the flange 37 of the cone, and an internal portion of the gravity concentrator/centrifugal separator 10. Alternatively, one or more hardwired connections may be made directly with an adjacent control system/network which incorporates the functionalities of a sensor 60. In some embodiments, hardwired connections may comprise USB (e.g., standard, mini, or micro plugs) or other type of serial bus connections. While not shown, the bus hardwired connections may incorporate daisy-chain geometries between adjacent detectors 34 to minimize cable runs through the shaft on which the cone assembly 32 rotates.

Regarding controls, one or more tactile dome switches may be provided on a front overlay of each sensor 60 to provide entry and navigation for a sensor configuration mode. Such means may provide the setting of a sensor 60 address (e.g., #1, 2, 3, . . . , N) as well as customization and optimization of all detectors 34 connected to that sensor 60. The respective sensor 60 may remain attached to the bus throughout configuration, and in most instances, will not likely interfere with normal operation of other sensors 60 (that is, if multiple sensors 60 are used).

As implied by the appending drawings, a method for the continuous monitoring of wear in concentrator circuits is disclosed. According to some embodiments, the method may include any number of the following steps: providing a concentration circuit, such as a gold concentration circuit having at least one gravity concentrator/centrifugal separator 10; providing a cone assembly 32 to the at least one gravity concentrator/centrifugal separator 10, the cone assembly 32 comprising a cone 30, a rotor housing shell 20, and a water jacket 40 therebetween; providing one or more sacrificial wear detectors and/or one or more pressure transducers to the cone assembly 32 in any number or fashion; providing one or more sensors 60 which are configured to continually monitor an operating state of the detectors 34 provided; monitoring the state of the detectors 34 while the at least one gravity concentrator/centrifugal separator 10 is operating; determining when it is an appropriate time to repair, replace, or check a cone 30 or otherwise modify operational parameters based on information provided from the detectors 30 and sensors 60 (e.g., adjust RPM, increase RPM, reduce RPM, adjust slurry feed rate, increase slurry feed rate, decrease slurry feed rate, adjust water jacket 40 pressure, increase water jacket 40 pressure, decrease water jacket 40 pressure, adjust run cycle time, increase run cycle time, reduce run cycle time, adjust concentrate discharge rate, increase concentrate discharge rate, decrease concentrate discharge rate, etc.); attending to the problem with the correct solution (e.g., replacing worn cone 30, refurbishing a worn cone 30, shutting down the gravity concentrator/centrifugal separator 10 for maintenance, slowing the machine RPM down, speeding the machine RPM, or increasing a residence time/run cycle time to accommodate for losses in recovery or performance of the gravity concentrator/centrifugal separator 10, etc.).

While not shown, a visual client display may be utilized when practicing the invention. The display may, for instance, comprise any one or more of the following: an image which is representative of a cone assembly 32, cone 30, rotor housing shell 20, or combination thereof, one or more status icons indicating an overall condition of the cone assembly 32, cone 30, rotor housing shell 20, or combination thereof, one or more status icons indicating one or more local instantaneous or average pressures at various areas of the cone assembly 32, cone 30, rotor housing shell 20, or combination thereof, one or more icons indicating a status of the controller, a graph showing real-time wear for each location of the cone assembly 32, cone 30, rotor housing shell 20, or combination thereof, a set of trough/valley and/or peak/ridge number icons (e.g., in order from upper to lower, or lower to upper), a set of trough/valley and/or peak/ridge status icons, and an icon showing the overall condition of a sensor 60.

In some non-limiting embodiments, one or more detectors 34 may be treated with a surface texture, a number of nibs, ribs, or other protuberances, in order to increase the bonding with the polymer (e.g., polyurethane) which is used to mold the cone 30. Detectors 34, in some embodiments may be juxtaposed with respect to a cone center or oppositely-positioned in order to balance the cone 30 for high RPMs. In some embodiments, one or more counterweights may be provided to ensure a balanced cone assembly 32 and minimize vibration during operation.

At least one sensor 60 may be provided to the housing of the gravity concentrator/centrifugal separator 10 (preferably, an upper centrally-disposed portion of the housing), to receive information from the detectors 34. With regard to wear-type detectors 34, depending on the amount of wear experienced by the cone 30, the sensor 60 may not pick up a signal from every detector 34. In such instances, when a signal from a particular detector 34 ceases to be read by the sensor 60, an alarm may be tripped indicating that a predetermined amount of wear has been realized at the location of the cone 30 which pertains to said particular detector 34 that ceases to be read by the sensor 60.

### Example 2

A plurality of 433 MHz RFID tags (e.g., a quantity of 5-10) may be provided to a skeleton frame of a matrix cone, and then secured to skeletal frame members (i.e., “ribs”) at predetermined locations. The radial locations of the tags may be selected to be a predetermined radial distance from the center axis of rotation of the cone. The radial locations may also be representative of a predetermined maximum threshold of usable cone life, and may be configured so that when they are exposed, and/or sacrificially worn, they cease providing signals to a compatible RFID interrogator/reader which may be equipped with a data-logging unit. The RFID interrogator/reader may be a handheld reader which can be placed proximate a gravity concentrator/centrifugal separator that receives the cone having tags embedded therein.

The frame and tags attached thereto are placed into a mold, and polyurethane is cast over the frame to form a cone having tags embedded therein. A size fit of tag check may be required for G4/G5/G6 FLSmidth Knelson concentrator cone sizes. Since passive (smaller) tags are said not to work in presence of water, they may be advantageously utilized as sacrificial detectors. Since permissions to inspect a cone inside of a concentrator onsite can take more than four hours, this inspection time can be saved utilizing the reader/interrogator sensor to determine a status of the RFID tags.

### Example 2

A detector-laden XD48 matrix cone may be provided for testing at a selected mine site having a tank containing slurry for processing. Pressure read points may be selected along a water jacket (e.g., at outer cone or inner rotor housing shell locations), as well as at the back of predetermined concentrating ring locations. Either Option 1 or Option 2 may be employed.

With Option 1, a slip ring union provides 24 VDC power to detectors within the cone, whose signals may be received through the slip ring union or transmitted out of the concentrator to a receiver unit which may be equipped with a data-logging unit, or otherwise indirectly to a control system integrated with a receiver which is capable of receiving, processing, and interpreting the signal. With Option 2, standalone wireless detectors embedded within the cone may transmit data to the receiver unit.

Detector options may include: 4-20 mA output pressure transducers+wireless transmitters, wireless water sensors, OTS TPMS kits, or Prescale/pressure-sensing film(s). Multiple pressure sensors may be embedded for an in-house test version. Testing may be performed and test results may be used scale down to define pressure points for field trials.

The detector-laden cone may be tested at a mine site at various RPMs and/or water flow rates using water (+silica).

### Example 3

A TPMS (Tire Pressure Monitoring System) may be used with a concentrator cone. For example, a TPMS comprising four (4) sensors+monitor may be utilized. The sensors of the TPMS may be integrated with portions of the rotor housing shell and/or outer surfaces of the cone. A TPMS monitor capable of 4, 22, 38 simultaneous reads may be utilized to monitor the TPMS sensors integrated within the cone assembly during operation. Such embodiments utilizing off-the-shelf TPMS kits may not have the ability to output data to laptop or data-logger. A proof of concept test using TPMS sensors in a pressurized vessel may be made prior to placing them in a concentrator cone assembly. The TPMS sensor units may be tried in water/pressure and spinning in a cone ring. Data-logging/export options other than the provided TPMS monitor may be explored.

### Example 4

A pressure transducer may be combined with an RFID wireless transmitter in a manner illustrated in FIG. 10. For example, a 0-100 psi pressure transducer may be combined with a wireless transmitter and equipped with a 12 VDC power supply. In some embodiments, off-the-shelf combinations of pressure sensors and RFID tags may be utilized, or they may be developed specifically for the concentrator purposes disclosed herein. It is anticipated that as sensor technology improves, such systems will exhibit increased performance in combination with concentrator cone monitoring applications. Prototypes may be made for several sensor/transmitter combinations, each combination using at least one receiver for rapid proof-of-concept tests. It is envisaged that separate receivers for pressure and wear may be utilized; however, it is preferred that a single sensor be configured to handle both functions. It is also envisaged that a combination of sacrificial and probe-style detectors may be employed, for redundancy or as a safeguard.

Although the invention has been described in terms of particular embodiments and applications, one of ordinary skill in the art, in light of this teaching, can generate additional embodiments and modifications without departing from the spirit of or exceeding the scope of the claimed invention. For example, various aspects of the invention (whether alone or in combination) may be incorporated in a lab-size concentrators, batch concentrators, or continuous concentrators, without limitation. Detectors 34 discussed herein may comprise active reader passive tags (ARPT), active reader active tags (ARAT), or battery-assisted passive (BAP) tags without limitation, and they may operate at any preferred frequency within any useable band including: LF (120-150 kHz) for distances between detectors and sensors under 0.1 meters, HF (13.56 MHz) for distances between detectors and sensors under 1 meters. The detectors discussed herein may also operate within the UHF (e.g., 433 MHz, 865-868 MHz, or 902-928 MHz) or microwave (2450-5800 MHz) spectrums for much larger distances between detectors and sensors. In some embodiments, the detectors discussed herein may comprise multi-frequency (MF) RFID tags, and the sensors 60 discussed herein may comprise a multi-frequency reader. In some embodiments, detectors 34 discussed herein may comprise self-powered RF-emitting wireless micro-transmitters (e.g., comprising radioisotope batteries), and sensors 60 discussed herein may comprise receivers tuned to the same frequency as said RF-emitting wireless micro-transmitters. In some embodiments, data may be provided in a programmable automation controller (PAC) or programmable logic controller (PLC) that is addressable from a plant control network. In such instances, OPC (i.e., object linking and embedding OLE for process control) and the high overhead/complexities of distributed component object model (DCOM) configurations may be avoid by using other common protocols such as Ethernet/IP, Modbus (RTU-, ASCII-, or TCP-frame formats), and/or combinations thereof (e.g., Modbus TCP/IP open-mbus).

It should be further noted that the particular geometries of components shown in the drawings are merely schematic representations and may vary from what is shown, and it is anticipated by the inventor that any number of variations and/or combinations of features or elements described herein may be practiced without departing from the scope of the invention. For example, while multiple detectors 34 may be shown as being arranged in a generally radial and/or vertical alignment within a cone 30, they may be alternatively aligned in other ways, directions, or spatial orientations, such as generally perpendicular to the axis of cone 30 rotation (so as to detect incremental reductions in thickness of a cone 30), staggered, and/or randomly positioned within a cone 30. Moreover, detectors 34 (where used herein) may be swapped for sensors 60 (where used herein) without limitation. Alternatively, detectors 34 may be omitted and only sensors 60 configured to perform detector 34 functions may be provided within a cone 30. In such instances, when a sensor 60 of a particular cone 30 stops working, the respective cone may have likely reached a predetermined amount of wear and may be ready for replacement or refurbishment.

Accordingly, it is to be understood that the drawings and descriptions herein are proffered by way of example to facilitate comprehension of the invention and should not be construed to limit the scope thereof.

### REFERENCE NUMERAL IDENTIFIERS

10 gravity concentrator/centrifugal separator
12 feed pipe inlet
14 concentrate discharge outlet
20 rotor housing shell
30 cone
31 fluidization holes
32 cone assembly
33 trough/valley/shallow/groove
34 detectors
35 peak/ridge/rim/crest
36 frame structural member
37 upper flange
38 frame
39 outer surface of the cone
40 water jacket
50 launder
60 sensor
70 motor
P1 first pressure
P2 second pressure
P3 third pressure
P4 fourth pressure
P5 fifth pressure
A first pressure transducer and transmitter device
B second pressure transducer and transmitter device
C third pressure transducer and transmitter device
D fourth pressure transducer and transmitter device
E fifth pressure transducer and transmitter device
F sixth pressure transducer and transmitter device

1. A system for the continuous monitoring of wear and/or pressure, comprising:
(a) a gravity concentrator/centrifugal separator configured to concentrate a mineral value from a slurry, the gravity concentrator/centrifugal separator comprising an assembly comprising a cone, a rotor housing shell, and a water jacket therebetween;
(b) at least one detector provided to at least one of the cone rotor housing shell, and water jacket; and
(c) at least one sensor provided to the gravity concentrator/centrifugal separator which is configured to communicate with the at least one detector during operation of the gravity concentrator/centrifugal separator;
wherein in use, wear or a change in localized pressure ultimately affects a function of the least one detector; and,
wherein, by virtue of communication with the at least one detector, the at least one sensor is configured to monitor said function of the least one detector and determine an operational status of the respective cone, rotor housing shell, or water jacket provided with the at least one detector.

2. The system of claim 1, wherein the at least one detector comprises an RFID tag and the at least one sensor comprises a reader/interrogator.

3. (canceled)

4. (canceled)

5. (canceled)

6. The system of claim 1, wherein the at least one detector comprises a magnet and the at least one sensor comprises a Hall Effect sensor.

7. The system of claim 1, wherein the at least one detector comprises a wafer-style probe comprising a printed circuit board (PCB).

8. The system of claim 1, wherein the at least one detector comprises a radioisotope capable of emitting alpha particles and/or low energy gamma rays, and the at least one sensor comprises a radioisotope detector/identifier.

9. The system of claim 1, wherein the at least one detector comprises a self-powered RF-emitting wireless micro-transmitter, and the at least one sensor comprises a receiver tuned to the same frequency as said RF-emitting wireless micro-transmitter.

10. The system of claim 1, wherein the at least one detector communicates with the sensor wirelessly.

11. The system of claim 1, wherein the at least one detector is hardwired to the at least one sensor to facilitate communication therebetween.

12. The system of claim 1, wherein multiple detectors are provided to the respective cone, rotor housing shell, and water jacket provided with the at least one detector.

13. The system of claim 1, wherein at least one detector is provided to multiple elements within the concentrator/centrifugal separator, the elements being selected from the group consisting of: a cone, a rotor housing shell, and a water jacket.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. An assembly for the continuous monitoring of wear and/or pressure, comprising:
(a) a cone or a rotor housing shell configured for use within a gravity concentrator/centrifugal separator for concentrating a mineral value from a slurry, wherein the cone and rotor housing shell are configured to form a water jacket [40] when assembled; and
(b) at least one detector provided to the cone or rotor housing shell; wherein the at least one detector is configured to communicate with at least one sensor via a signal during operation of the gravity concentrator/centrifugal separator;
wherein in use, wear or a change in localized pressure ultimately affects a function of the least one detector; and,
wherein, by virtue of communication with the at least one detector, said function of the least one detector may be monitored by at least one sensor when in use; and wherein an operational status of the at least one detector is capable of being monitored and determined by the at least one sensor when in use.

26. The assembly of claim 25, wherein the at least one detector comprises an RFID tag.

27. The assembly of claim 25, wherein the at least one detector comprises a magnet.

28. The assembly of claim 25, wherein the at least one detector comprises a wafer-style probe comprising a printed circuit board (PCB).

29. The assembly of claim 25, wherein the at least one detector comprises a radioisotope capable of emitting alpha particles and/or low energy gamma rays.

30. The assembly of claim 25, wherein multiple detectors are provided to the cone or a rotor housing shell.

31. The assembly of claim 30, wherein said multiple detectors are provided to different radial or circumferential portions of the cone or a rotor housing shell.

32. The assembly of claim 30, wherein said at least one detector is provided to the cone or a rotor housing shell as a separate component.

33. The assembly of claim 30, further comprising a cavity within the cone or a rotor housing shell and said at least one detector is provided within one or more threaded inserts or plugs which are inserted into the cavity.

34. The assembly of claim 30, wherein at least one detector is molded into a cavity formed in the cone or a rotor housing shell.
